(19) United States
(12) Patent Application Publication
(10) Pub. No.: US 2002/0182476 A1
(43) Pub. Date: Dec. 5, 2002

(54) Method for preparing fuel cell component substrate of flexible graphite material having improved thermal and electrical properties

(76) Inventors: Robert Anderson Reynolds III, Bay Village, OH (US); Robert Angelo Mercuri, Seven Hills, OH (US); Ronald Alfred Greinke, Medina, OH (US)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 09/871,001

(22) Filed: May 31, 2001

(51) Int. Cl. H01M 4/96; B05D 5/12; B32B 9/00

(52) U.S. Cl. 429/44; 427/115; 428/408

(57) ABSTRACT

A method enables preparation of a stock or starting material having improved thermal and/or electrical properties along with a desired set of other properties. These materials will be useful in the formation of articles adapted for use in electrochemical fuel cells and supercapacitors.

### TECHNICAL FIELD

The invention relates to a flexible graphite material which can be used for the preparation of graphite articles of improved electrical and/or thermal properties which are useful as components in electrochemical devices such as fuel cells and double-layer capacitors.

### BACKGROUND OF THE INVENTION

The production of efficient, low-cost electrochemical devices like fuel cells and capacitors is dependent upon the availability of highly-conductive construction materials.

Electrochemical devices like fuel cells and double-layer capacitors are foreseen by some as necessary to the commercial realization of low-emission vehicles as well as a number of stationary power needs. Fuel cells cleanly and efficiently convert suitable fuels to electrical energy, while supercapacitors are useful for storing and releasing large bursts of energy. The unique advantages of each type of device make them, alone and together, promising for many power applications. In all cases, a balance must be struck between weight and performance, and it would be desirable to adjust manufacturing procedures of current construction materials to assure that both concerns are effectively addressed to provide a net improvement in the operation and/or economy of these devices.

Fuel cell components such as fluid flow field plates (FFP's) and gas diffusion layers (GDL's) should exhibit both high thermal and electrical conductivities. They also are required to have sufficient strength to support their particular functions. The ability to design and produce key elements with desired electrical, thermal and strength characteristics depends on the provision of procedures and materials that enable modifying limiting factors to meet the needs of a particular utility without diminishing the other characteristics of the material. Where this cannot be done, it is frequently necessary to compensate for insufficient electrical or thermal conductivities during the design phase—often leading to a less-than-ideal compromise on key structural and performance criteria. Each instance where a choice is made to increase electrical or thermal conductivity by reducing the amount of material employed or by increasing density, there is an increased chance that minimum structural specifications will not be met. Also, in each instance where material distribution is altered to achieve improved thermal or electrical characteristics, other characteristics can be affected. It would be desirable to enable more nearly meeting competing design criteria by improving the thermal and/or electrical conductivity of flexible graphite sheet.

Among the fuel cells utilizing flow field plates (FFP's) and gas diffusion layers (GDL's) where flexible graphite foil could be of advantage are ion exchange membrane fuel cells. Material selection and processing often favors flexible graphite foil due to its overall favorable combination of physical and electrical properties. Proton exchange membrane (PEM) fuel cells are of particular interest. Cells of this type produce electricity through the chemical reaction of hydrogen with oxygen from the air. Within the fuel cell, electrodes denoted as anode and cathode, surround a polymer electrolyte to form what is generally referred to as a membrane electrode assembly (or MEA). In some cells, the electrode component will also function as a GDL. A catalyst material stimulates hydrogen molecules to split into hydrogen atoms and then, at the membrane, the atoms each split into a proton and an electron. The electrons are utilized as electrical energy. The protons migrate through the electrolyte and combine with oxygen and electrons to form water.

A PEM fuel cell is advantageously formed of a membrane electrode assembly sandwiched between two graphite flow field plates. Conventionally, the membrane electrode assembly consists of random-oriented carbon fiber paper electrodes (anode and cathode) with a thin layer of a catalyst material, particularly platinum or a platinum group metal coated on isotropic carbon particles, such as lamp black, bonded to either side of a proton exchange membrane disposed between the electrodes.

In operation of one of these PEM cells, hydrogen flows through channels in one of the flow field plates to the anode, where the catalyst promotes its separation into hydrogen atoms and thereafter into protons that pass through the membrane and electrons that flow through an external load. Air flows through the channels in the other flow field plate to the cathode, where the oxygen in the air is separated into oxygen atoms, which join with the protons migrating through the proton exchange membrane and the electrons through the circuit. The result is the generation of current and the formation of water. Since the membrane is an insulator, the electrons cannot directly cross the membrane, but seek the least resistance and travel through an external circuit which utilizes the electricity before the electrons join the protons at the cathode. An air stream on the cathode side is one mechanism by which the water formed by combination of the hydrogen and oxygen can be removed. Combinations of such fuel cells are used in a fuel cell stack to provide the desired voltage.

One factor limiting the full potential of flexible graphite materials as components for PEM fuel cells is the need for even better electrical and thermal conductivity while still providing a thickness suitable for a high-definition embossed pattern to direct fluid flow in a cell. If the pattern of channels in the FFP is not desirably precise and regular, anomalies in fuel cell operation may result, by either permitting leaking of fluids, or not permitting sufficient fluid flow through the fuel cell. Aggravating this problem are several opposing problems. There is a need for a suitable structural material, which can readily be shaped at one surface to conform to the surface of an intricately-shaped mold and yet have another surface that is sufficiently dense as to be impermeable under the conditions of operation to yield an overall structure having desired characteristics in terms of electrical and thermal conductivity and the like.

Double-layer capacitors, sometimes also called ultracapacitors and supercapacitors, are capable of rapidly charging to store significant amounts of energy and then delivering the stored energy in bursts on demand. To be useful, they must, among other properties, have low internal resistance, store large amounts of charge and be physically strong per unit weight. There are, therefore, a large number of design parameters that must be considered in their construction. It would be desirable to enable procedures for producing starting materials for producing component parts that would address these concerns such that the final supercapacitor assembly could be more effective on a weight and/or cost basis.

Double-layer capacitors generally include two porous electrodes, kept from electrical contact by a porous separator. Both the separator and the electrodes are immersed within an electrolyte solution. The electrolyte is free to flow through the separator, which is designed to prevent electrical contact between the electrodes and short-circuiting the cell. Current collecting plates are in contact with the backs of active electrodes. Electrostatic energy is stored in polarized liquid layers, which form when a potential is applied across the two electrodes. A double layer of positive and negative charges is formed at the electrode-electrolyte interface.

The use of graphite electrodes in electrochemical capacitors with high power and energy density provides a number of advantages, but economics and operating efficiency are in need of improvement. Fabrication of double layer capacitors with carbon electrodes is known. See, for example, U.S. Pat. No. 6,094,788, to Farahmandhi, et al., U.S. Pat. No. 5,859,761, to Aoki, et al., U.S. Pat. No. 2,800,616, to Becker, and U.S. Pat. No. 3,648,126, to Boos, et al. the disclosures of all of these references are hereby incorporated by reference herein for their disclosures of capacitor structures and materials. The art has been utilizing graphite electrodes—but not made of flexible graphite—for capacitors of this type for some time and is still facing challenges in terms of material selection and processing. For example, Farahmandhi, et al., describe a method for increasing the conductivity of electrodes by spraying the carbon substrate with aluminum metal. It would be of benefit to employ flexible graphite for electrodes and to utilize it in a form having increased thermal and/or electrical conductivity.

A continuing problem in many carbon electrode capacitors, including double-layer capacitors, is that the performance of the capacitor is limited because of the internal resistance of the carbon electrodes. While the use of carbon in the form of flexible graphite sheet will have several advantages, it would be desired to further reduce cell internal resistance. Internal resistance is influenced by several factors, the most important of which is the chemical makeup of the material itself. While having a very favorable balance of properties, flexible graphite sheet could be improved if its electrical conductivity could be increased. Because high resistance translates to large energy losses in the capacitor during charging and discharge, and these losses further adversely affect the characteristic RC (resistance×capacitance) time constant of the capacitor and interfere with its ability to be efficiently charged and/or discharged in a short period of time, it would be desirable to provide construction materials and methods that would facilitate reductions in the internal resistance. Thermal conductivity is also important and any increase in this property would be an advantage.

To better understand the complexity of the above considerations, we present a brief description of graphite and the manner in which it is typically processed to form flexible sheet materials. Graphite, on a microscopic scale, is made up of layer planes of hexagonal arrays or networks of carbon atoms. These layer planes of hexagonally arranged carbon atoms are substantially flat and are oriented or ordered so as to be substantially parallel and equidistant to one another. The substantially-flat, parallel, equidistant sheets or layers of carbon atoms, usually referred to as graphene layers or basal planes, are linked or bonded together and groups thereof are arranged in crystallites. Highly-ordered graphite materials consist of crystallites of considerable size: the crystallites being highly aligned or oriented with respect to each other and having well ordered carbon layers. In other words, highly ordered graphites have a high degree of preferred crystallite orientation. It should be noted that graphites, by definition, possess anisotropic structures and thus exhibit or possess many characteristics that are highly directional, e.g., thermal and electrical conductivity and fluid diffusion. Sometimes this anisotropy is an advantage and at others it can lead to process or product limitations.

Briefly, graphites may be characterized as laminated structures of carbon, that is, structures consisting of superposed layers or laminae of carbon atoms joined together by weak van der Waals forces. In considering the graphite structure, two axes or directions are usually noted, to wit, the “c” axis or direction and the “a” axes or directions. For simplicity, the “c” axis or direction may be considered as the direction perpendicular to the carbon layers. The “a” axes or directions may be considered as the directions parallel to the carbon layers or the directions perpendicular to the “c” direction. The graphites suitable for manufacturing flexible graphite sheets possess a very high degree of orientation.

As noted above, the bonding forces holding the parallel layers of carbon atoms together are only weak van der Waals forces. Natural graphites can be chemically treated so that the spacing between the superposed carbon layers or laminae can be appreciably opened up so as to provide a marked expansion in the direction perpendicular to the layers, that is, in the “c” direction, and thus form an expanded or intumesced graphite structure in which the laminar character of the carbon layers is substantially retained.

Graphite flake which has been chemically or thermally expanded and more particularly expanded so as to have a final thickness or “c” direction dimension that is as much as about 80 or more times the original “c” direction dimension, can be formed without the use of a binder into cohesive or integrated sheets of expanded graphite, e.g. webs, papers, strips, tapes, or the like (typically referred to as “flexible graphite”). The formation of graphite particles which have been expanded to have a final thickness or “c” dimension which is as much as about 80 times or more the original “c” direction dimension into integrated flexible sheets by compression, without the use of any binding material, is believed to be possible due to the mechanical interlocking, or cohesion, which is achieved between the voluminously expanded graphite particles. Sheet material resulting from very high compression, e.g. roll pressing has excellent flexibility, good strength and a very high degree of orientation.

Briefly, the process of producing flexible, binderless anisotropic graphite sheet material, e.g. web, paper, strip, tape, foil, mat, or the like, comprises compressing or compacting under a predetermined load and in the absence of a binder, expanded graphite particles which have a “c” direction dimension which is as much as about 80 or more times that of the original particles so as to form a substantially flat, flexible, integrated graphite sheet. The expanded graphite particles that generally are worm-like or vermiform in appearance will, once compressed, maintain the compression set and alignment with the opposed major surfaces of the sheet. Controlling the degree of compression can vary the density and thickness of the sheet material.

Lower densities are sometimes thought to be advantageous in some forms of processing where required surface detail is formed by embossing or molding. Lower densities can sometimes aid in achieving good detail. However, strength, thermal conductivity and electrical conductivity are generally favored by more dense sheets. Typically, the density of the sheet material will be within the range of from about 0.04 g/cc to about 1.4 g/cc. It would be desirable to have a process that would permit improving thermal and electrical conductivity of these materials.

Flexible graphite sheet material made as described above typically exhibits an appreciable degree of anisotropy due to the alignment of graphite particles parallel to the major opposed, parallel surfaces of the sheet, with the degree of anisotropy increasing upon roll pressing of the sheet material to increased density. In roll-pressed anisotropic sheet material, the thickness, i.e. the direction perpendicular to the opposed, parallel sheet surfaces comprises the “c” direction and the directions ranging along the length and width, i.e. along or parallel to the opposed, major surfaces comprises the “a” directions and the thermal, electrical and fluid diffusion properties of the sheet are very different, by orders of magnitude typically, for the “c” and “a” directions. It would be desirable to have a process which would permit increasing thermal and/or electrical conductivity when needed.

There remains a need in the art for a material of improved electrical and/or thermal conductivity which can be used in preparing flexible graphite articles. If available, such needed materials and methods for making them would aid the formation of an array of final products, including components for electrochemical double-layer capacitors and fuel cells.

### SUMMARY OF THE INVENTION

Accordingly, it is an object of the invention to provide a material having an array of desirable properties, including good electrical and/or thermal conductivity that can be used in preparing flexible graphite articles useful in making electrochemical devices.

It is a more particular object of the invention to provide methods and materials enabling the preparation of shaped elements having improved electrical and/or thermal characteristics to improve the operation of electrochemical devices including articles prepared from them.

It is another object of the invention to enable the production of a variety of shaped component parts having unique electrical and/or thermal properties.

It is another object of the invention to provide a process for enabling the manufacture of preformed blanks having unique electrical and/or thermal conductivity characteristics, which are useful in the production shaped objects for electrochemical cells.

It is another specific object of the invention to provide materials and methods helpful in improving performance per unit weight for a variety of shaped articles useful as components in electrochemical supercapcitors and fuel cells.

It is another object of the invention to provide materials and methods which enable good thermal and electrical conductivity in flexible graphite foil substrates, while permitting molding or shaping the materials with good detail.

These and other objects are accomplished by the present invention, which provides a material useful as a substrate for forming electrochemical elements and methods for preparing materials of this type.

The material of the invention is useful as a substrate for preparing a variety of articles, the material comprising: a compressed sheet of graphite having graphite intercalation compounds included therein.

According to the process of the invention, flexible graphite sheet is intercalated to an extent necessary to form graphite intercalation compounds which increase the conductivity of the graphite sheet and are stable in electrolytic devices. The intercalated sheet can be formed into a variety of shapes by a variety of processes.

The graphite intercalation compounds can be selected for improving thermal and/or electrical conductivity of the sheet material and articles made from it.

Many preferred and alternative aspects of the invention are described below.

### DETAILED DESCRIPTION OF THE INVENTION

The invention will be illustrated and explained in this description by specific reference to the production of a stock material of flexible graphite sheet having improved electrical and/or thermal properties that is suitable for use in electrochemical devices such as fuel cells of the PEM type and double-layer capacitors. It will be recognized, however, that while this description is made for illustrative purposes, the invention has broader applicability and is useful in the production of materials for many other end uses.

Central to all of the embodiments of the invention is the provision of a flexible graphite sheet material (also termed “foil”) which is formed from exfoliated graphite and then further processed according to the invention to improve its properties.

The material of the invention is useful as a substrate for preparing articles such as an embossed or unembossed flexible graphite sheet and comprises a compressed sheet of graphite comprised of intercalated graphite particles having graphite intercalation compounds included therein. The material of the invention is made by intercalating with a material suitable for the purpose and to an extent necessary to form graphite intercalation compounds which increase the conductivity of the graphite sheet and are stable in electrolytic devices. The intercalated sheet can be formed into a variety of shapes by a variety of processes. The graphite intercalation compounds can be selected for improving thermal and/or electrical conductivity of the sheet and articles made from it.

The starting material for the invention is any of the suitable flexible graphite sheet materials as are commercially available in a variety of grade and thicknesses and densities for a variety of end uses. Preferred starting materials can be binder free before and after processing or can be impregnated or coated with a suitable binder, preferably after intercalation of the sheet to improve electrical and/or thermal properties according to the invention. Suitable flexible graphite starting materials are available under the trademarks GRAFOIL® and GRAFCELL™ from Graftech, Inc. The sheet material, preferably after intercalation, can be impregnated with resin, such as an acrylic-, epoxy- or phenolic-based resin system, prior to shaping, such as by layering, with or without cutting, and then pressing with at least one shaping member, such as by embossing. Advantageously, the resin is cured during or after the step of shaping the flexible graphite sheet. The resin content of the resin-impregnated flexible graphite sheet material is preferably at least about 5%, and more preferably at least about 10%, by weight.

In the course of this description, we will refer to flexible graphite sheet or foil, and we mean to use these terms interchangeably. The term “flexible graphite sheet” in this context is meant to refer to an article made of compressed, exfoliated graphite either by itself or with one or more fillers or binders, wherein parallel surfaces of particles of graphite are oriented principally in a plane perpendicular to the “c” direction of the graphite particles and the thickness of the article in the direction parallel to the “c” direction is less than about 1.5 mm. The invention will have particular advantage when dealing with thin sheets, namely those of less than about 1.0 mm in thickness. Sheets having thicknesses in the range of from about 0.05 to about 0.5 mm will have particular advantage for some applications. For others, thicknesses of from 0.2 to 0.75 mm will be preferred. In yet others the range can be a narrow low range of from about 0.075 to about 0.2 mm. The flexible graphite sheet material is preferably of low area weight, e.g., from about 0.001 to about 1.4 g/cm², to facilitate impregnation and subsequent handling in roll form where that might be useful. In some cases, area weights of less than 0.5, e.g., from 0.1 to 0.4, will be useful. In others area weights of from above 0.5 to 1.4, e.g., from 0.6 to 1.0, will be useful. The flexible graphite sheet material can be of any desired density, e.g., from about 0.1 to about 1.8 g/cm³. To facilitate processing in some cases, densities of less than 1.0, e.g., from 0.1 to 0.9 g/cm³, will be useful. In others densities of greater than 1.2, e.g., from 1.2 to 1.4, g/cm³ will be useful. Mid range densities of from about 1.0 to about 1.2 g/cm³ are effective in many applications. Advantageously, thinner materials within the above ranges may be rolled into coils and transported as a continuous sheet rather than cut into pieces for shipment to facilitate processing and saves material.

Before describing the manner in which the invention improves current materials, a brief description of graphite and its formation into flexible sheets, which will become the primary substrate for forming the products of the invention, is in order.

Preparation of Flexible Graphite Foil

Graphite is a crystalline form of carbon comprising atoms covalently bonded in flat layered planes with weaker bonds between the planes. By treating particles of graphite, such as natural graphite flake, with an intercalant of, e.g. a solution of sulfuric and nitric acid, the crystal structure of the graphite reacts to form a compound of graphite and the intercalant. The treated particles of graphite are hereafter referred to as “particles of intercalated graphite.” Upon exposure to high temperature, the intercalant within the graphite decomposes and volatilizes, causing the particles of intercalated graphite to expand in dimension as much as about 80 or more times its original volume in an accordion-like fashion in the “c” direction, i.e. in the direction perpendicular to the crystalline planes of the graphite. The exfoliated graphite particles are vermiform in appearance, and are therefore commonly referred to as worms. The worms may be compressed together into flexible sheets that, unlike the original graphite flakes, can be formed and cut into various shapes and provided with small transverse openings by deforming mechanical impact.

Graphite starting materials suitable for use in the present invention include highly graphitic carbonaceous materials capable of intercalating organic and inorganic acids as well as halogens and then expanding when exposed to heat. These highly graphitic carbonaceous materials most preferably have a degree of graphitization of about 1.0. As used in this disclosure, the term “degree of graphitization” refers to the value g according to the formula:

$$g = \frac{3.45 - d ( 002 )}{0.095}$$

where d(002) is the spacing between the graphitic layers of the carbons in the crystal structure measured in Angstrom units. The spacing d between graphite layers is measured by standard X-ray diffraction techniques. The positions of diffraction peaks corresponding to the (002), (004) and (006) Miller Indices are measured, and standard least-squares techniques are employed to derive spacing which minimizes the total error for all of these peaks. Examples of highly graphitic carbonaceous materials include natural graphites from various sources, as well as other carbonaceous materials such as carbons prepared by chemical vapor deposition and the like. Natural graphite is most preferred.

The graphite starting materials used in the present invention may contain non-carbon components so long as the crystal structure of the starting materials maintains the required degree of graphitization and they are capable of exfoliation. Generally, any carbon-containing material, the crystal structure of which possesses the required degree of graphitization and which can be intercalated and exfoliated, is suitable for use with the present invention. Such graphite preferably has an ash content of less than 20% (weight), and for electrochemical uses less than 6% is often desired. More preferably, the graphite employed for the present invention will have a purity of at least about 94%. In the most preferred embodiment, the graphite employed will have a purity of at least about 99% for electrochemical fuel cell uses.

A common method for manufacturing graphite sheet is described by Shane et al. in U.S. Pat. No. 3,404,061, the disclosure of which is incorporated herein by reference. In the typical practice of the Shane et al. method, natural graphite flakes are intercalated by dispersing the flakes in a solution containing e.g., a mixture of nitric and sulfuric acid, advantageously at a level of about 20 to about 300 parts by weight of intercalant solution per 100 parts by weight of graphite flakes (pph). The intercalation solution contains oxidizing and other intercalating agents known in the art. Examples include those containing oxidizing agents and oxidizing mixtures, such as solutions containing nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfuric acid and nitric acid, or mixtures of a strong organic acid, e.g. trifluoroacetic acid, and a strong oxidizing agent soluble in the organic acid. Alternatively, an electric potential can be used to bring about oxidation of the graphite. Chemical species that can be introduced into the graphite crystal using electrolytic oxidation include sulfuric acid as well as other acids.

In a preferred embodiment, the intercalating agent is a solution of a mixture of sulfuric acid, or sulfuric acid and phosphoric acid, and an oxidizing agent, i.e. nitric acid, perchloric acid, chromic acid, potassium permanganate, hydrogen peroxide, iodic or periodic acids, or the like. The intercalation solution may also contain metal halides such as ferric chloride, and ferric chloride mixed with sulfuric acid, or a halide, such as bromine, as a solution of bromine and sulfuric acid or bromine, in an organic solvent.

The quantity of intercalation solution may range from about 20 to about 150 pph and more typically about 50 to about 120 pph. After the flakes are intercalated, any excess solution is drained from the flakes and the flakes are water-washed. Alternatively, the quantity of the intercalation solution may be limited to between about 10 and about 50 pph, which permits the washing step to be eliminated as taught and described in U.S. Pat. No. 4,895,713, the disclosure of which is also herein incorporated by reference.

The particles of graphite flake treated with intercalation solution can optionally be contacted, e.g. by blending, with a reducing organic agent selected from alcohols, sugars, aldehydes and esters which are reactive with the surface film of oxidizing intercalating solution at temperatures in the range of 25° C. and 125° C. Suitable specific organic agents include hexadecanol, octadecanol, 1-octanol, 2-octanol, decylalcohol, 1,10-decanediol, decylaldehyde, 1-propanol, 1,3-propanediol, ethyleneglycol, polypropylene glycol, dextrose, fructose, lactose, sucrose, potato starch, ethylene glycol monostearate, diethylene glycol dibenzoate, propylene glycol monostearate, glycerol monostearate, dimethyl oxylate, diethyl oxylate, methyl formate, ethyl formate, ascorbic acid and lignin-derived compounds, such as sodium lignosulfate. The amount of organic reducing agent is suitably from about 0.5 to 4% by weight of the particles of graphite flake.

The use of an expansion aid applied prior to, during or immediately after intercalation can also provide improvements. Among these improvements can be reduced exfoliation temperature and increased expanded volume (also referred to as “worm volume”). An expansion aid in this context will advantageously be an organic material sufficiently soluble in the intercalation solution to achieve an improvement in expansion. More narrowly, organic materials of this type that contain carbon, hydrogen and oxygen, preferably exclusively, may be employed. Carboxylic acids have been found especially effective. A suitable carboxylic acid useful as the expansion aid can be selected from aromatic, aliphatic or cycloaliphatic, straight chain or branched chain, saturated and unsaturated monocarboxylic acids, dicarboxylic acids and polycarboxylic acids which have at least 1 carbon atom, and preferably up to about 15 carbon atoms, which is soluble in the intercalation solution in amounts effective to provide a measurable improvement of one or more aspects of exfoliation. Suitable organic solvents can be employed to improve solubility of an organic expansion aid in the intercalation solution.

Representative examples of saturated aliphatic carboxylic acids are acids such as those of the formula H(CH₂)ₙCOOH wherein n is a number of from 0 to about 5, including formic, acetic, propionic, butyric, pentanoic, hexanoic, and the like. In place of the carboxylic acids, the anhydrides or reactive carboxylic acid derivatives such as alkyl esters can also be employed. Representative of alkyl esters are methyl formate and ethyl formate. Sulfuric acid, nitric acid and other known aqueous intercalants have the ability to decompose formic acid, ultimately to water and carbon dioxide. Because of this, formic acid and other sensitive expansion aids are advantageously contacted with the graphite flake prior to immersion of the flake in aqueous intercalant. Representative of dicarboxylic acids are aliphatic dicarboxylic acids having 2-12 carbon atoms, in particular oxalic acid, fumaric acid, malonic acid, maleic acid, succinic acid, glutaric acid, adipic acid, 1,5-pentanedicarboxylic acid, 1,6-hexanedicarboxylic acid, 1,10-decanedicarboxylic acid, cyclohexane-1,4-dicarboxylic acid and aromatic dicarboxylic acids such as phthalic acid or terephthalic acid. Representative of alkyl esters are dimethyl oxylate and diethyl oxylate. Representative of cycloaliphatic acids is cyclohexane carboxylic acid and of aromatic carboxylic acids are benzoic acid, naphthoic acid, anthranilic acid, p-aminobenzoic acid, salicylic acid, o-, m- and p-tolyl acids, methoxy and ethoxybenzoic acids, acetoacetamidobenzoic acids and, acetamidobenzoic acids, phenylacetic acid and naphthoic acids. Representative of hydroxy aromatic acids are hydroxybenzoic acid, 3-hydroxy-1-naphthoic acid, 3-hydroxy-2-naphthoic acid, 4-hydroxy-2-naphthoic acid, 5-hydroxy-1-naphthoic acid, 5-hydroxy-2-naphthoic acid, 6-hydroxy-2-naphthoic acid and 7-hydroxy-2-naphthoic acid. Prominent among the polycarboxylic acids is citric acid.

The intercalation solution will be aqueous and will preferably contain an amount of expansion aid of from about 1 to 10%, the amount being effective to enhance exfoliation. In the embodiment wherein the expansion aid is contacted with the graphite flake prior to or after immersing in the aqueous intercalation solution, the expansion aid can be admixed with the graphite by suitable means, such as a V-blender, typically in an amount of from about 0.2% to about 10% by weight of the graphite flake.

After intercalating the graphite flake, and following the blending of the intercalant coated intercalated graphite flake with the organic reducing agent, the blend is exposed to temperatures in the range of 25° to 125° C. to promote reaction of the reducing agent and intercalant coating. The heating period is up to about 20 hours, with shorter heating periods, e.g., at least about 10 minutes, for higher temperatures in the above-noted range. Times of one half hour or less, e.g., on the order of 10 to 25 minutes, can be employed at the higher temperatures.

The thus treated particles of graphite are sometimes referred to as “particles of intercalated graphite.” Upon exposure to high temperature, e.g. temperatures of at least about 160° C. and especially about 700° C. to 1000° C. and higher, the particles of intercalated graphite expand as much as about 80 to 1000 or more times their original volume in an accordion-like fashion in the c-direction, i.e. in the direction perpendicular to the crystalline planes of the constituent graphite particles. The expanded, i.e. exfoliated, graphite particles are vermiform in appearance, and are therefore commonly referred to as worms. The worms may be compressed together into flexible sheets that, unlike the original graphite flakes, can be formed and cut into various shapes and provided with small transverse openings by deforming mechanical impact as hereinafter described.

Flexible graphite sheet and foil are coherent, with good handling strength, and are suitably compressed, e.g. by roll-pressing, to a thickness of about 0.075 mm to 3.75 mm and a typical density of about 0.1 to 1.4 grams per cubic centimeter (g/cc). From about 1.5-30% by weight of ceramic additives can be blended with the intercalated graphite flakes as described in U.S. Pat. No. 5,902,762 (which is incorporated herein by reference) to provide enhanced resin impregnation in the final flexible graphite product. The additives include ceramic fiber particles having a length of about 0.15 to 1.5 millimeters. The width of the particles is suitably from about 0.04 to 0.004 mm. The ceramic fiber particles are non-reactive and non-adhering to graphite and are stable at temperatures up to about 1100° C., preferably about 1400° C. or higher. Suitable ceramic fiber particles are formed of macerated quartz glass fibers, carbon and graphite fibers, zirconia, boron nitride, silicon carbide and magnesia fibers, naturally occurring mineral fibers such as calcium metasilicate fibers, calcium aluminum silicate fibers, aluminum oxide fibers and the like.

Preparation of Intercalated Sheet Graphite Materials

The invention provides a material useful as a substrate for an embossed flexible graphite sheet by intercalation of flexible graphite foil prepared in the manner described above or other suitable process involving intercalation, exfoliation and sheeting. In its preferred forms, a flexible graphite foil of this type is obtained and then further intercalated with the objective of intercalating with chemical species and to a degree to enhance thermal and/or chemical properties of the resulting material and any articles formed therefrom to improve their performance in electrochemical devices such as fuel cells and double-layer capacitors.

In a principal distinction from the commercial flexible graphite sheet materials as made from particles of intercalated graphite described above, the products of the invention are comprised of significant quantities of graphite intercalation compounds. In further distinction from commercial flexible graphite foil, it is found that halide intercalation compounds are useful in electrochemical processes for improving electrical and/or thermal conductivity. The invention has the further advantage that metal-containing intercalation compounds can be formed and can enhance the performance of electrochemical components where such activity is useful. On a weight basis, the materials of the invention can comprise at least 1%, typically from 3 to 20%, of one or more graphite intercalation compounds.

To improve the electrical and/or thermal conduction properties of flexible graphite based fuel cell components, flexible graphite sheet is intercalated using methods known in the art, such as those processes described above. In order to avoid repetition, that description will not be repeated in this section, and can be easily adapted to sheet with reference to the examples below. Also, while not related to flexible graphite sheet, the disclosures of U.S. Pat. Nos. 4,414,142, 5,260,124, 5,316,080, 5,224,030, and 5,414,142, are incorporated herein by reference for their disclosure of intercalation procedures and materials. Also, incorporated by reference is the publication of Akuzawa, et al.; “Effect of inserted molecules on the electrical conductivity of CsC₂₄”; Carbon 39 (2001) 300-303. Depending on the specific application, it may be desirable to intercalate to improve electrical conductivity while sacrificing thermal conductivity. Some applications might actually benefit from the combination of improved electrical conductivity and decreased thermal conductivity.

Intercalation can be conducted with the intercalant in any suitable physical form and concentration at temperatures and pressures effective to achieve the desired results in terms of composition of graphite intercalation compounds and their concentration in the sheet material of the invention. Typically, the intercalant will be in liquid form and is selected from the group consisting of halogens, mixed halogens, halides, oxidizing acids, alkali metals, transition metals and combinations of some of these where that might be desirable. In some cases it is helpful to volatilize the intercalant. If desired, a potential can be impressed to facilitate intercalation. Prominent among the alkali metals are sodium, potassium, rubidium and cesium. Among the common transition metals are those in the Periodic Table of the Elements as 21 though 29, 39 though 47, 57 through 79 and 89 and on. Mentioned of these and are iron, aluminum, copper, nickel, manganese, cobalt and tungsten. Of the oxidizing acids we mention nitric acid, sulfuric acid, perchloric acid and chromic acid. Suitable metal halides include copper chloride, nickel chloride, ferric chloride, aluminum chloride, manganese chloride and the like.

Following intercalation, the sheet is compressed, such as by compression rollers or molding in a multipart compression mold. The compression step can impart a suitable surface configuration to the material and can emboss a suitable complex or other pattern into the sheet, such as described in International Publication No. WO 00/64808, the disclosure of which is incorporated herein by reference. Final product densities of from about 0.001 to about 2.5 grams/cm³, typically less than 2.2, and more narrowly from 0.01 to about 1.5 grams/cm³, can be effective for producing a variety of final products. In other cases, densities of from about 0.05 to about 0.5 grams/cm³ will be desired. In others the range will be from about 0.5 to 1.0 grams/cm³. The thickness of the sheets can vary over a wide range, e.g., from 0.075 to 1.4 mm, typically being under 1 mm and greater than 0.01 mm.

Electrical properties can be improved by the invention, preferably by at least about 5%, and preferably by at least 10%. In the case of electrical conductivity, there is no upper limit on the desirable increase, and increases of greater than 25% and even higher than 100% will be desirable for electrochemical applications. It is an advantage of the invention that conductivities can be improved in applications where needed to achieve the desired properties for the material of the invention and components made from it. In some cases an electrical conductivity within the range of from 1.0 to 7.6×10⁷ Ω⁻¹m⁻¹ is effective for electrochemical uses. And, thermal conductivity within the range of 5 to 2000 W/m K are advantageous for some applications. Electrical resistivities of less than about 8 μohm-meter, and preferably less than 5 μohm-meter, e.g., from 0.1 to 4 μohm-meter can be effective as representative.

Laminates of the sheet material with any of a variety of other substrates can have utility. Among these other materials are GRAFOIL® and GRAFCELL™ flexible graphite foils having the same or different thickness or other property, such as composition. For example, a sheet can be intercalated according to the invention and then laminated to a similar untreated material or one with a mineral filler as taught above.

The intercalated sheet material can be impregnated, preferably following compression. One embodiment of an apparatus for continuously forming resin-impregnated and calendered flexible graphite sheet is shown in International Publication No. WO 00/64808 the disclosure of which is incorporated herein by reference. The resin-impregnation step will enhance the stability of the intercalated sheet preserving the increased electrical and thermal properties compared to the non-intercalated graphite sheet.

The following examples are presented to further illustrate and explain the invention and are not intended to be limiting in any regard. Unless otherwise indicated, all parts and percentages are by weight.

### EXAMPLE 1

A low-density flexible graphite mat (0.1 g/cc) was subjected to bromine vapors at room temperature in an enclosed chamber for 24 hours. The vapors were generated in the chamber from a pool of liquid bromine placed at the bottom of the chamber. After removal and equilibration in air for 24 hours, the weight pickup of the bromine-intercalated mat was 4%. The low-density mat was rolled into a foil with a thickness of 0.58 mm and a density of 1.1 g/cc. The in-plane electrical resistivity of this foil was measured and compared to a control with no bromine treatment. The electrical resistivity of the bromine treated foil was only 4.9 μohm-meter compared to 8.4 μohm-meter for the control. The electrical resistivity was reduced 42% for the bromine-intercalated foil. This foil could be embossed into an article that can be used in a fuel cell device or other applications where low resistivity or high conductivity is important.

### EXAMPLE 2

A low-density flexible graphite mat was subjected to iodine monochloride vapors in an enclosed chamber at 60° C. for 24 hours. The vapors were generated in the chamber from a pool of liquid iodine monochloride placed at the bottom of the chamber. After removal and equilibration in air for 24 hours, the weight pickup of iodine monochloride intercalated mat was 14.6%. The low-density mat was rolled into a foil with a thickness of 0.58 mm and a density of 1.25 g/cc. The in-plane electrical resistivity of this foil was measured and compared to a control with no iodine monochloride treatment. The electrical resistivity of the iodine monochloride treated foil was only 1.3 μohm-meter compared to 7.4 μohm-meter for the control. The electrical resistivity was reduced 85% for the iodine monochloride intercalated sheet. This foil could be embossed into an article that can be used in a fuel cell device or other applications where low resistivity or high conductivity is important.

### EXAMPLE 3

The intercalation of sheet with CuCl₂ is performed by heating the graphite sheet (0.1 g/cc) in the presence of CuCl₂ in an atmosphere of chlorine gas to >500° C. for a minimum of 60 minutes.

### EXAMPLE 4

The procedure of Example 1 is repeated, but this time the resulting sheet is then compressed and shaped by passing it between a pair of pressure rollers.

### EXAMPLE 5

The procedure of Example 1 is repeated, but this time the resulting sheet is impregnated with phenolic resin to a resin content of 10% and is then compressed and shaped by passing it between a pair of pressure embossing rollers.

### EXAMPLE 6

The procedure of Example 5 is repeated, but this time the resulting sheet is impregnated with phenolic resin to a resin content of 10% after it is compressed and shaped by passing it between a pair of pressure embossing rollers.

### EXAMPLE 7

A sheet material as prepared in Example 1 is then impregnated with an epoxy resin by exposing the intercalated flexible graphite article to a solution of epoxy resin. The impregnated flexible graphite article is subsequently dried to remove any solvent and heated to thermoset the resin.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A material useful as a substrate for preparing articles, comprising:
a compressed sheet of graphite having graphite intercalation compounds included therein.

2. A material of claim 1 wherein the intercalant comprises a material selected from the group consisting of halogens, mixed halogens, halides, oxidizing acids, alkali metals, transition metals and mixtures.

3. A material of claim 1 which comprises at least 1% of one or more graphite intercalation compounds.

4. A material of claim 1 which comprises from 3 to 20% by weight of a graphite intercalation compound.

5. A material comprising at least one layer of a material of claim 1 and another layer of flexible graphite sheet.

6. A material of claim 1 which has a density of from about 0.1 to about 1.5 grams/cm³.

7. A material of claim 1 which has a thickness of from 0.075 to 1.4 mm.

8. A material of claim 1 which has an electrical conductivity within the range of from 1.0 to 7.6×10⁷ Ω⁻¹m⁻¹.

9. A material of claim 1 which has a thermal conductivity within the range of 5 to 2000 W/m K.

10. A material of claim 1 which has an electrical conductivity of less than about 8 μohm-meter.

11. A material of claim 1 wherein the sheet contains resin at a level of at least about 5% in the flexible graphite sheet.

12. A process for preparing a material useful as a substrate for preparing articles such as an embossed or unembossed flexible graphite sheet, comprising:
intercalating a sheet of flexible graphite to an extent necessary to form graphite intercalation compounds which increase the thermal and/or electrical conductivity of the graphite sheet; and
compressing the sheet following intercalation.

13. A process of claim 12 wherein the intercalant comprises a material selected from the group consisting of halogens, mixed halogens, halides, oxidizing acids, alkali metals, transition metals and mixtures.

14. A process of claim 12 wherein the sheet following intercalation comprises at least 1% of one or more graphite intercalation compounds.

15. A process of claim 12 wherein the sheet following intercalation comprises from 3 to 20% by weight of a graphite intercalation compound.

16. A process of claim 12 wherein at least one layer of a material of claim 1 is compressed with another layer of flexible graphite sheet.

17. A process of claim 12 wherein the final sheet has a density of from about 0.1 to about 1.5 grams/cm³.

18. A process of claim 12 wherein the final sheet has a thickness of from 0.075 to 1.4 mm.

19. A material of claim 12 wherein the final sheet has an electrical conductivity within the range of from 1.0 to 7.6×10⁷ Ω⁻¹m⁻¹.

20. A process of claim 12 wherein the final sheet has a thermal conductivity within the range of 5 to 2000 W/m K.

21. A process of claim 12 wherein the sheet contains resin at a level of at least about 5% in the flexible graphite sheet.

22. A material of claim 12 wherein the final sheet has an electrical resistivity of less than about 8 μohm-meter.
